(19) United States
(12) Patent Application Publication
(10) Pub. No.: US 2022/0017247 A1
(43) Pub. Date: Jan. 20, 2022

(54) METHOD OF PACKAGING SHELLFISH

(71) Applicant: Southern Cross Marine Culture R&D Pty Ltd, Tasmania (AU)

(72) Inventors: Timothy J. PAULY, Tasmania (AU); Shane G. MCHUGH, Tasmania (AU); Gideon J. HELLER-WAGNER, Tasmania (AU)

(73) Assignee: Southern Cross Marine Culture R&D Pty Ltd, Tasmania (AU)

(21) Appl. No.: 17/296,130

(22) PCT Filed: Nov. 21, 2019
(86) PCT No.: PCT/AU2019/051282

§ 371 Date: May 21, 2021

(30) Foreign Application Priority Data
Nov. 23, 2018 (AU) 2018904478

(51) Int. Cl. B65B 25/06; A01K 61/50; A01K 63/02; A23B 4/02; A23B 4/16; A23B 4/24; A23B 4/26; B65D 85/50; B65D 81/22

(52) U.S. Cl. CPC B65B 25/062; A01K 61/50; A01K 63/02; A23B 4/021; B65D 81/22; A23B 4/24; A23B 4/26; B65D 85/50; A23B 4/16

(57) ABSTRACT

A method of packaging live shellfish, the method including placing live shellfish in a sealable receptacle, inserting an oxygen-enriched, aqueous-based liquid medium in the receptacle in an amount that permits a gaseous-phase headspace within the receptacle, inserting a gas in the receptacle, the gas including oxygen, wherein the gas is inserted in an amount to fill the receptacle headspace with the gas, and sealing the receptacle to thereby retain the contents of the receptacle in a sealed environment.

### FIELD OF THE INVENTION

The present invention relates to a method of packaging shellfish, including, but not limited to, any one or more of oysters, mussels, clams, pipis, cockles, abalone, lobster or any other shellfish species that are to be transported and stored until ready for consumption or for the transportation of spat/seed in a live condition.

### BACKGROUND OF THE INVENTION

Shellfish are molluscs and include, but are not limited to, oysters, mussels, clams, pipis and scallops.

Live (unopened) shellfish are traditionally transported and stored in a dry, cool environment. For example, Sydney Rock oysters are typically stored between 10 and 21° C. whilst Pacific oysters are stored between 5 and 10° C. Other shellfish species such as mussels and pipis are also stored and transported between 5 and 10° C.

Live shellfish such as oysters have a limited shelf life once harvested (i.e., approx. 7 days for Pacific oysters and less for some native species). During this shelf life period, the product quality and freshness is in constant decline and the limited shelf life contributes to a number of problems, including increased holding costs associated with loss of product (estimated to be as high as 50% in some markets) and, as a result of the limited shelf life, the low-quality product ultimately presented to the customer. In this regard, the transport time from the aquatic farm to the consumer is lengthy. For example, in Australia, the domestic market is primarily serviced by road freight, and sometimes sea freight, which means the period from harvest to customer delivery takes up a significant component of the shellfish shelf life. Whilst air freight reduces the transport time, it significantly adds to the cost and increases complexity with regard to packaging and food and safety compliance requirements. Product shelf life is also a significant limitation when accessing export markets, given the extended and more complex supply chain required.

Freezing is the main method of increasing the shelf life, but frozen products are generally considered to be inferior as compared with live products by customers and therefore tend to attract lower prices. Hence, shellfish are generally only transported, sold and purchased as a frozen product during the lead up to peak sales periods.

Given the general perception by the public that live shellfish are more attractive as compared with frozen produce, most commercial shellfish businesses transport and sell shellfish whilst in a live state in a dry, cool environment and without the use of water. This requires live shellfish to be transported and sold within a short timeframe in order to ensure a viable product at the point of sale/consumption which poses both financial and logistical problems.

In an attempt to solve problems associated with the transport and sale of live shellfish within a short timeframe, some commercial shellfish businesses transport live shellfish in water tanks. However, the use of water tanks to transport molluscs is generally considered to be an expensive and complex process which requires extra precautions to be undertaken in order to ensure the molluscs are safe to consume.

Shellfish are also sometimes transported in a processed (i.e. half shelf opened) state positioned on molded trays (cup side down) in a mixed gas atmosphere comprising carbon dioxide and nitrogen. Whilst the mixed gas atmosphere reduces the microbial growth rates that lead to seafood spoilage, the opened shellfish nevertheless have a reduced shelf life of typically about 7 days when stored and transported in this condition.

The present invention is intended to address at least some of the above disadvantages associated with conventional methods of packaging, transporting and storing shellfish.

The reference to any prior art in this specification is not, and should not be taken as an acknowledgement, or any suggestion that, the prior art forms part of the common general knowledge at the priority date of the claims herein.

### SUMMARY OF THE INVENTION

In one aspect, the present invention provides a method of packaging live shellfish, the method including placing live shellfish in a sealable receptacle; inserting an oxygen-enriched, aqueous-based liquid medium in the receptacle in an amount that permits a gaseous-phase headspace within the receptacle, inserting a gas in the receptacle, the gas including oxygen, wherein the gas is inserted in an amount to fill the receptacle headspace with the gas, and sealing the receptacle to thereby retain the contents of the receptacle in a sealed environment.

In an embodiment, the aqueous-based liquid medium is saturated with oxygen gas in an amount that ensures a high level of oxygen is maintained in the liquid medium up until the receptacle is opened prior to consumption of the oysters. In an embodiment, the aqueous-based liquid medium is super-saturated with oxygen gas.

In an embodiment, the method may further include adding an agent to the liquid medium to substantially avoid the accumulation of ammonia excreted by the shellfish in the liquid medium. Examples of such suitable agents that may be added to the liquid medium include, but are not limited to, formulations including sodium formaldehyde bisulphite. In this regard, formulations including, but not limited to, Aquapure, Macroalgae (Ulva) sp, and Zeolite may be useful in avoiding, or at least, reducing the accumulation of ammonia. In this regard, it will be appreciated that ammonia is an undesirable by-product of shellfish metabolism that may reduce the longevity, quality and palatability of the oyster product.

In an embodiment, the gas may be a mixture of oxygen and one or more other gaseous components, including, but not limited to nitrogen, argon and helium. In an embodiment, the gas may be a mixture of at least about 80% oxygen and 20% one or more other gaseous components.

In an embodiment, one or more chemical compounds may be added to the liquid-based medium and/or the receptacle prior to sealing that may serve to extend the product shelf-life. Such chemical compounds may include, but are not limited to, salts such as magnesium chloride, calcium and/or sodium chloride.

In an embodiment, the temperature of the liquid is maintained at a temperature conducive to maintain the shellfish in a live state and a lowered metabolic rate. It will be understood that different shellfish species require different temperatures in order to be maintained in a live state and at optimal quality and freshness. The receptacle, once sealed, may be stored at approx. 2° C. to 8° C. in a chiller room prior to boxing and transport. In an embodiment, the liquid temperature may be reduced to a desired set-point prior to being inserted into the receptacle.

In an embodiment, the liquid may be seawater that has been filtered and sterilized. In this embodiment, seawater may be collected and filtered, for example, through a 5-micrometer filter to remove microorganisms, debris and other solid particles. The seawater may also be subjected to further treatment including sterilization using UV light treatment and/or ozone treatment in order to reduce the microbial/organic load.

In another aspect, the present invention provides a packaged product for transporting shellfish in a live state, the product including a sealed receptacle in which live shellfish are contained; an aqueous-based liquid; and a receptacle head-space filled with a gas including oxygen, and the aqueous-based liquid being supersaturated with the gas.

In an embodiment, the receptacle may be selected for mechanical durability, reducing the risk of leakage and to minimise the diffusion of gas through the receptacle walls. In an embodiment, the receptacle is a pouch or tray fabricated from multi-layered membranes/barrier films.

In an embodiment, the shellfish, for example, oysters, may be pre-treated prior to being placed in the receptacle. The pre-treatment is intended to reduce the microbial loading and waste products in order to further increase the shelf-life of the shellfish during transport and storage and maintain the quality of the product.

Typical pre-treatments may include, but are not limited to, mechanical cleaning by holding shellfish stock in high energy areas of aquatic farms to thereby clean the shellfish by the wind/wave effects of the seawater. Other mechanical treatments include, but are not limited to, rumbling, bushes and/or other scrubbing methods such as high-pressure water jets.

In embodiments, the shellfish may also be retained in treated (filtered and sterilized) seawater prior to being placed in the receptacle to empty the gut, reducing the detritus and also the biofouling of the packaged product.

In embodiments, the shellfish may also be subjected to chemical pre-treatment prior to being inserted in the receptacle. In an embodiment, the chemical pre-treatment includes bathing the live shellfish in a hydrogen peroxide solution. Other chemical pre-treatments include ozone gas and/or UV light that assists in further reducing the microbial loading and hence bio-fouling of the packaged product.

In some embodiments, a natural magnesium salt solution may also be added to the packaged product prior to sealing in an attempt to aid the shell opening (shucking) process of the live product at the point of consumption and/or food preparation.

Embodiments of the invention will now be described in further detail with reference to the accompanying figures.

### BRIEF DESCRIPTION OF THE DRAWINGS

FIGS. 1A, 1B and 1C provide an overview of the steps involved in preparing (treating) and packaging oysters according to an embodiment of the present invention.

FIG. 2 is an illustration of a typical commercial oyster lease comprising public water land for oyster cultivation.

FIG. 3 depicts the steps involved in treating mature oysters prior to harvesting same.

FIG. 4 depicts the steps involved in the collection of seawater for use in the packaging method and product according to an embodiment of the invention.

FIG. 5 depicts the steps involved in harvesting mature oysters.

FIG. 6 depicts the steps involved in cleaning and sorting of oysters post-harvest.

FIG. 7 depicts steps involved disinfecting and depurating oysters post-harvest.

FIG. 8 depicts the steps involved in conditioning the water to be used in the packaging method and product according to an embodiment of the present invention.

FIG. 9 depicts placement of live oysters in a multi-layer membrane pouch that is used as a receptacle according to an embodiment of the invention.

FIG. 10 shows the step of filling up the multi-layer membrane pouch shown in FIG. 9 with sterilized and oxygen-saturated water.

FIG. 11 shows filling of the headspace of the multi-layer membrane pouch shown in FIGS. 9 and 10 with pure oxygen gas according to an embodiment of the present invention.

FIG. 12 illustrates the step of sealing the multi-layer membrane pouch shown in FIGS. 9 to 11 by means of a heat-seal according to an embodiment of the present invention.

FIG. 13 illustrates the storage and shipping of the packaged live oysters according to an embodiment of the present invention.

FIG. 14 depicts the step of adding a salt preparation (magnesium chloride) to the package once opened and prior to consumption of the oysters.

FIG. 15 shows the results of testing conducted to identify an appropriate ammonia-control agent for application to the oyster packaging.

FIG. 16 shows the results of testing conducted to determine the optimum dosage level of the Aquapure ammonia-control agent.

### DETAILED DESCRIPTION OF EMBODIMENT(S) OF THE INVENTION

For convenience, the invention will be described with respect to a particular embodiment directed to packaging of oysters, however it will be appreciated by those skilled in the art that the invention is not limited to this particular embodiment.

Oyster farming operations can be broadly divided into four stages, namely (i) spat collection, (ii) cultivation (iii) harvesting and (iv) packaging/transport and sale.

Spat, or juvenile oysters, are initially collected for subsequent cultivation and harvest primarily to avoid risk of predation from predators such as fish. Spat collection involves the use of spat collectors (either plastic slats or tar coated sticks) that provide a maximum surface area upon which spat may settle. Spat collectors are also configured to enable the ready removal of the oysters without damage. Once spat have settled upon the spat collectors in sufficient numbers, and have grown to a sufficient size so that predation is not a risk, the juvenile oysters are removed from the spat collectors and moved to an area within the oyster lease (i.e., a public water way leased to an oyster farmer for the purpose of cultivating oysters for sale) that provides higher nutrient loads thereby promoting oyster growth (cultivation).

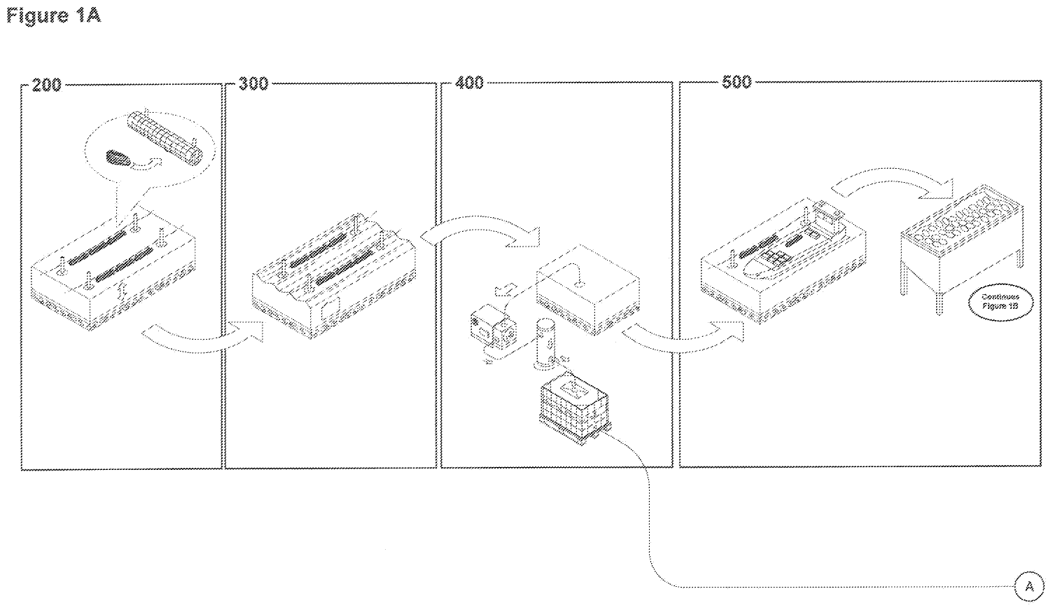

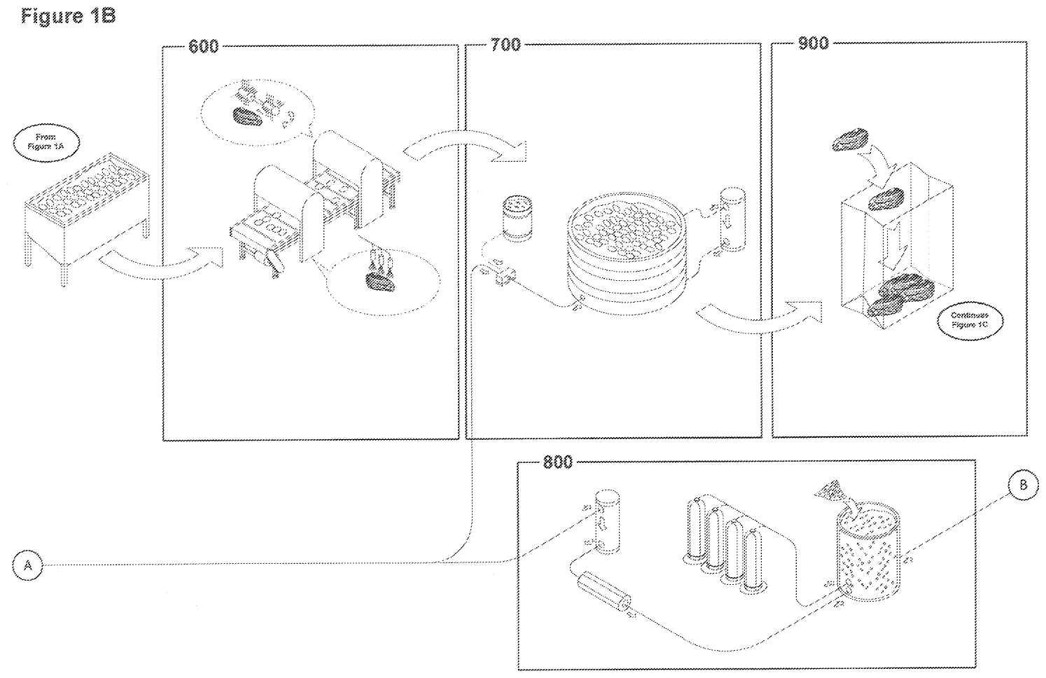

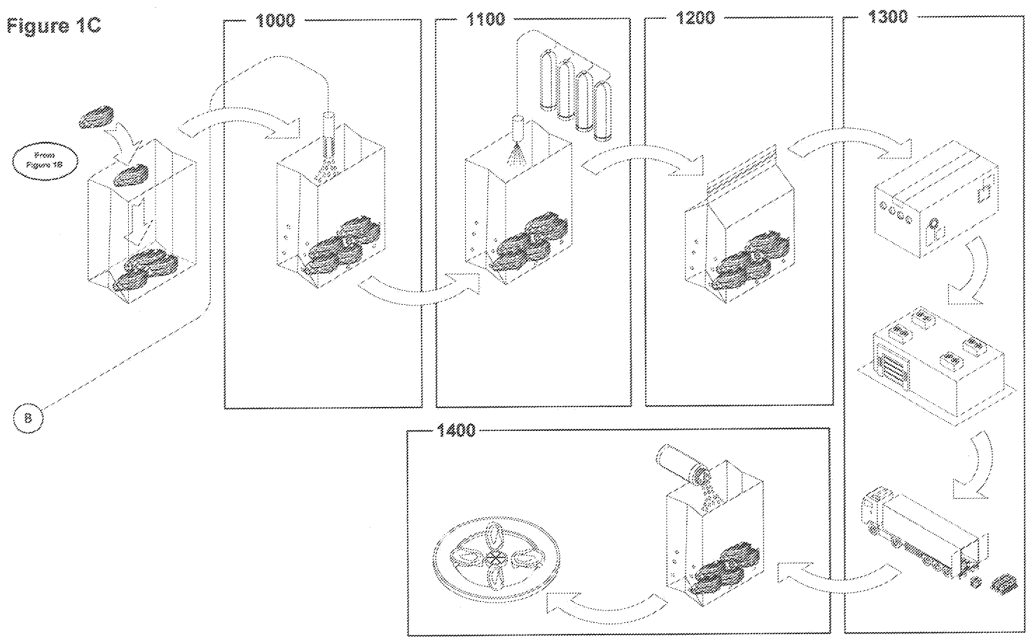

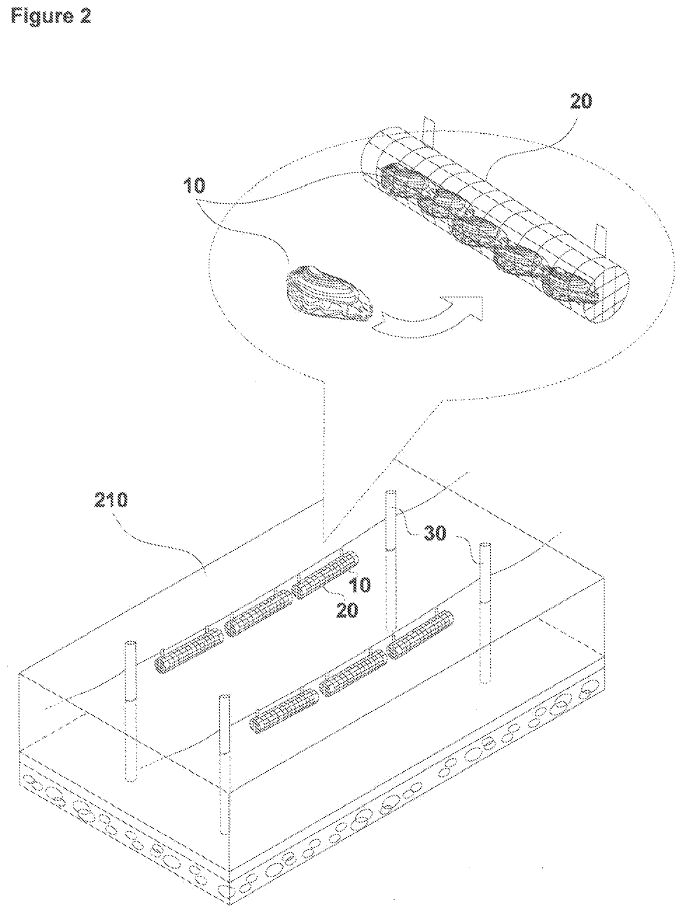

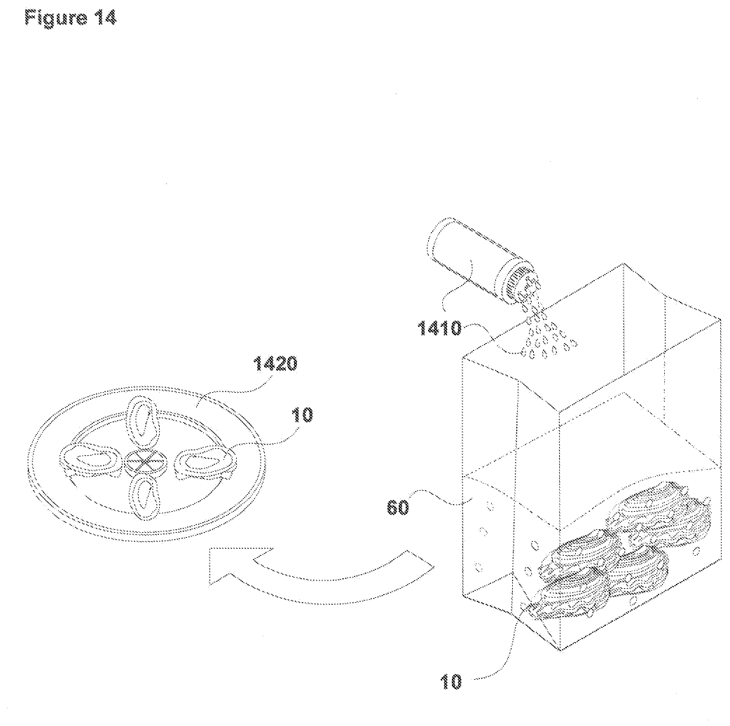

An overview of the steps involved in cultivating, treating, harvesting and packaging of the oysters according to an embodiment of the present invention is provided in FIGS. 1A to 1C. Each of these steps (depicted in blocks 200-1400) are individually shown and described in further detail in FIGS. 2 to 14.

Oyster cultivation is typically performed using either the “rack and rail” system or a “long-line” system. The “rack and rail” system involves the use of containers supported on a rack built in the oyster lease that holds the oysters. In contrast, the “long-line” system consists of a single line on which baskets containing oysters can be clipped or hung. The “long-line” system of cultivation is shown in FIG. 2 in which oysters (10) are placed in baskets (20) suspended from lines that are supported by poles (30) driven into the base of the oyster lease (210).

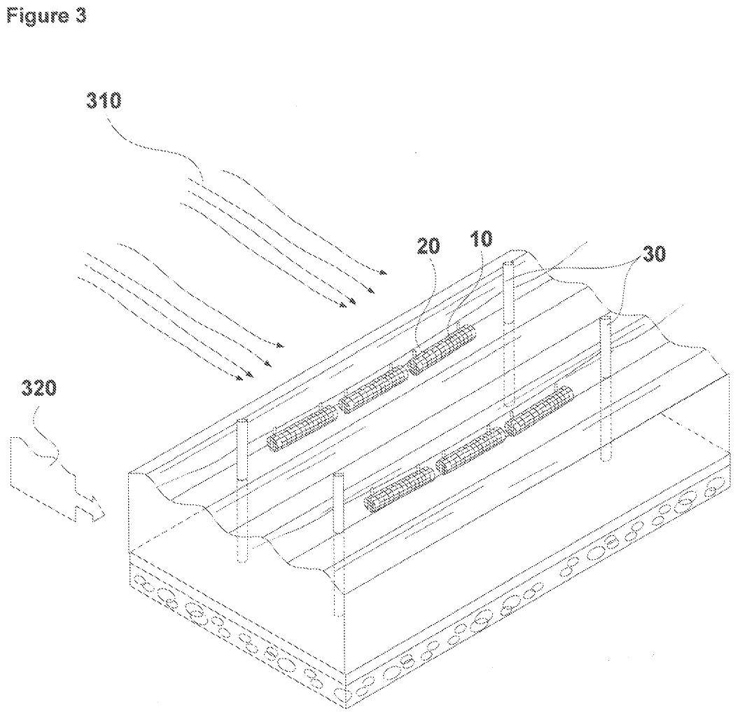

Prior to harvesting, mature oysters (10) are moved to “high energy” areas of the oyster lease for cleaning, toughening and conditioning. It will be understood that the “high energy” areas of the oyster lease are subject to prevailing winds (310) and waves (320) as shown in FIG. 3. Under such wind/wave effects, the oyster stock is rumbled and cleaned by mechanical action thereby reducing biofouling of the stock in preparation for packaging, transport and sale. Subjecting the oysters to such wind/wave and/or tidal effects also assists in toughening the oyster (by strengthening the adductor muscle) which further assists in prolonging the shelf-life of the oysters.

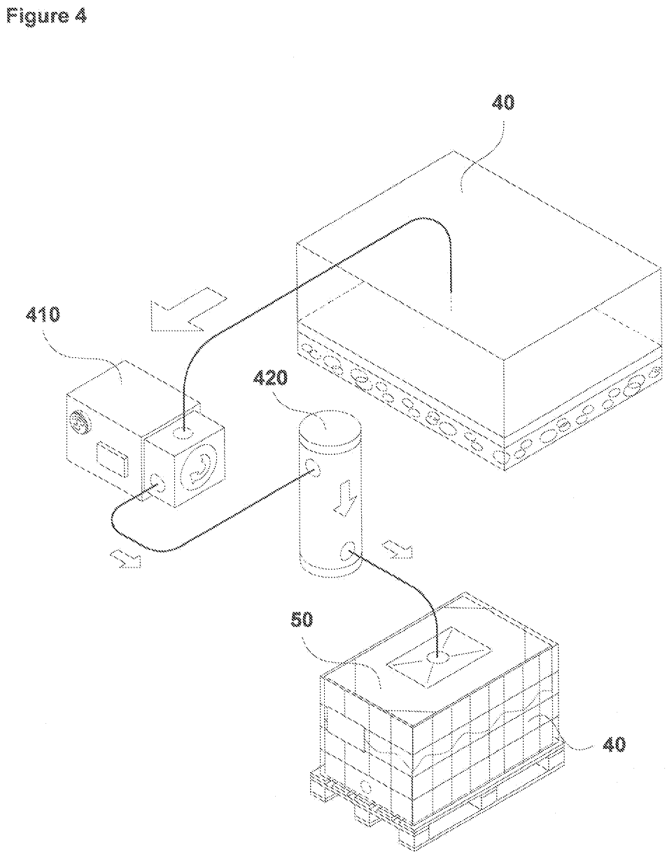

FIG. 4 shows how seawater (40) is collected from the lease to be used as the aqueous based liquid medium in the receptacle (pouch) within which oysters are placed. The collection of seawater (40) from the lease from which the oysters are harvested assists in ensuring various regulatory and export requirements are met since this practice avoids the introduction of any extraneous pollutants, residues and/or contaminants from foreign seawaters. Prior to inserting the seawater (40) in the pouch, the seawater (40) is passed, by the use of pump (410), through a 5-micron filtration system (420) and collected in 1000 litre Intermediate Bulk Containers (50) in preparation for the oyster packaging process.

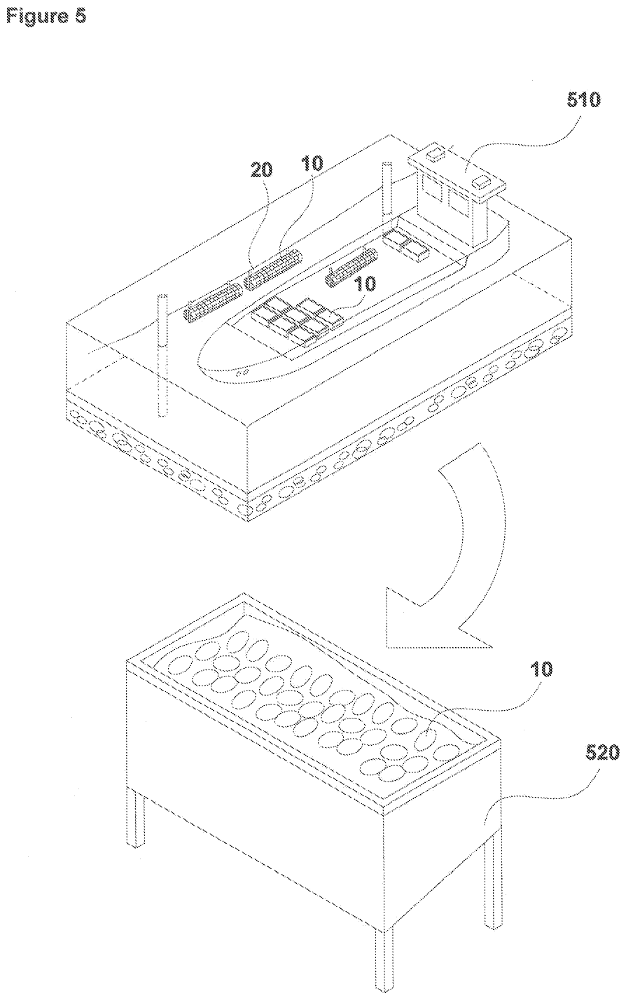

Referring to FIG. 5, once the oysters have matured to the point where they are ready for harvest, the mature oysters (10) are removed from baskets (20) and placed in bins which are stacked on vessels (510). The mature oysters (10) are subsequently emptied into bulk bin containers (520) for transport to a processing facility where they are subjected to further cleaning, sorting and sizing/grading prior to packaging.

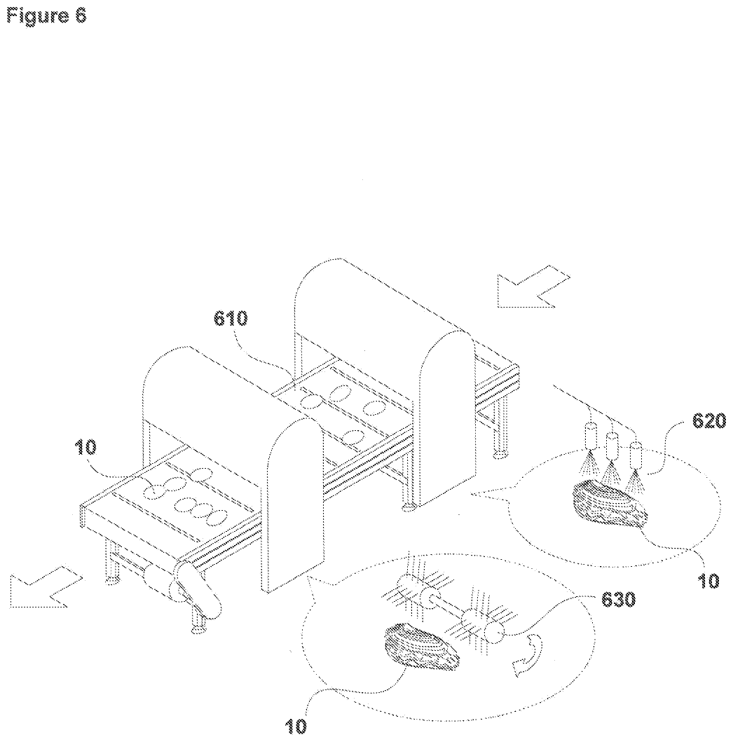

FIG. 6 illustrates the steps of cleaning and sorting the mature oysters (10). This is achieved by transporting oysters (10) along conveyor belts (610) through a washing unit where the oysters are sprayed with jets of pressurized water (620) and/or are subjected to mechanical scrubbing by the use of rotary scrubber (630). The high-pressure water cleaning and/or mechanical scrubbing assists to remove surface organic material and potential by-catch from the shell of oysters prior to packaging.

The oysters are also subjected to a sorting step where any dead or irregularly shaped oysters are manually discarded. Following the sorting step, the oysters are then subjected to a grading (sizing) step by the use of a Shellfish Equipment Design Vision Grader (SED), where the oysters are separated in categories including “bistro”, “buffet”, “standard” and “large”.

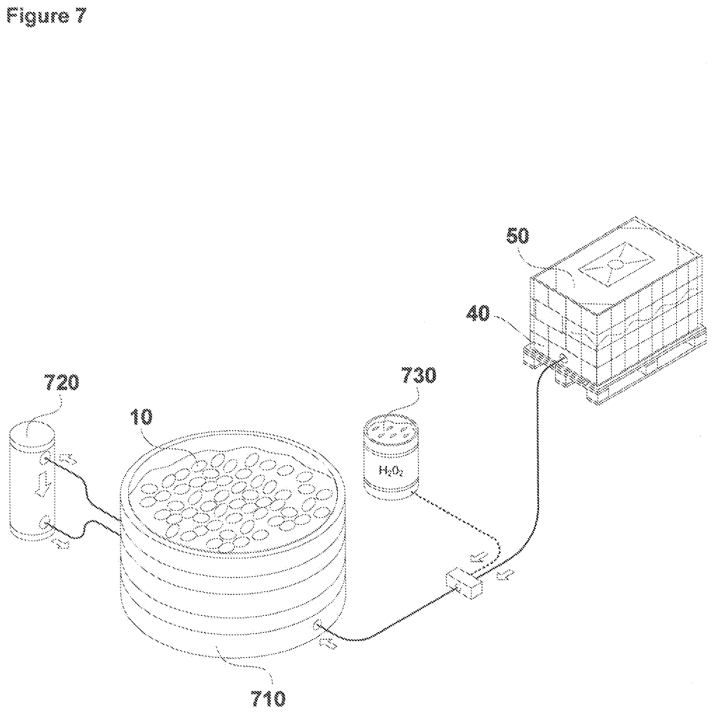

With reference to FIG. 7, after being cleaned, sorted and graded, the oysters (10) are further subjected to disinfection and depuration steps, to reduce the microbial and organic load and thereby assist in prolonging the shelf-life. The purification step involves bathing the oysters in an aqua-culture tank (710) comprising seawater (40) supplied from the pre-treated seawater stored in the Intermediate Bulk Containers (50). Seawater (40) is continuously filtered through filtration unit (720) and dosed with hydrogen peroxide (20-50 mg/litre) that is pumped from storage tank (730). The hydrogen peroxide assists in killing any external and, possibly, internal bacteria and parasites existing on, or in, the oysters. The oysters are left to sit in the aqua-culture tank (710) for approximately 24 hours to ensure removal of substantially all solid materials such as the oyster gut contents and dead organisms and also to allow the hydrogen peroxide to dissipate. After this time, the oysters are ready for placement in barrier pouches comprising multi-layered membranes, and are thus impermeable to liquids and gases, as part of the packaging process.

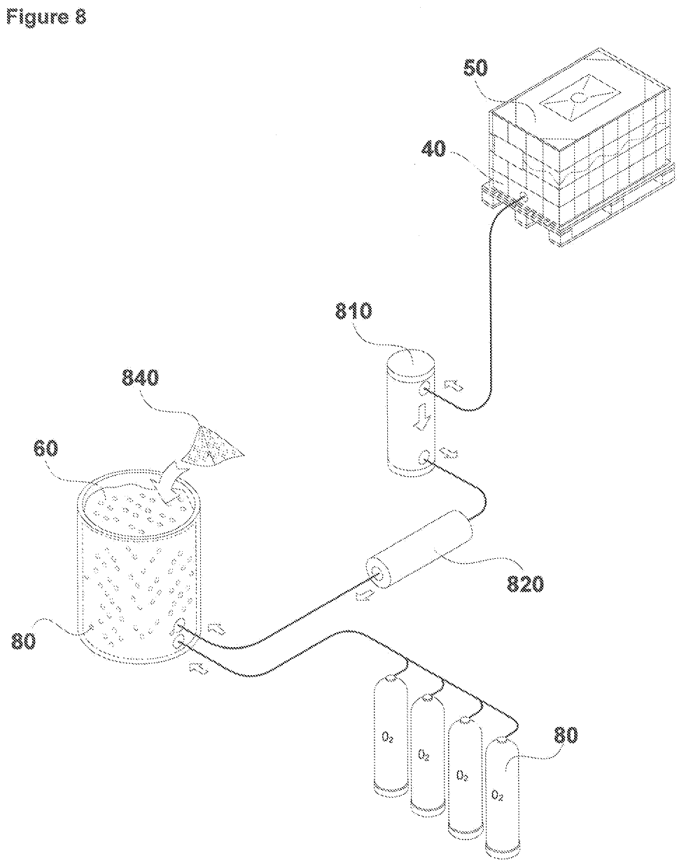

Referring to FIG. 8, prior to being inserted in the multi-layer membrane pouches, treated seawater (40) stored in Intermediate Bulk Containers (50) is subjected to further treatment (conditioning) which includes filtering the treated seawater (40) through a 1-micron filtration bag (810) and exposing same to ultraviolet light (820) to produce sterile seawater (60). The sterile seawater (60) is flushed with oxygen gas stored in oxygen cylinders (80) using a ceramic stone diffuser until the water is super-saturated with oxygen gas at a saturation level of approx. 200-500%.

Still referring to FIG. 8, an agent (840) is also added to the sterile seawater (60) to control the accumulation of ammonia in the package. In this regard, it will be appreciated that ammonia is a natural by-product excreted by shellfish which produces an objectionable odour when present in high amounts.

In an attempt to determine an appropriate agent for controlling the accumulation of ammonia for application in the liquid medium, the inventors conducted a series of initial trials in which three agents (Aquapure, Ulva sp., and Zeolite) were tested for their ability to avoid, or reduce, the accumulation of ammonia excreted by the packaged oysters.

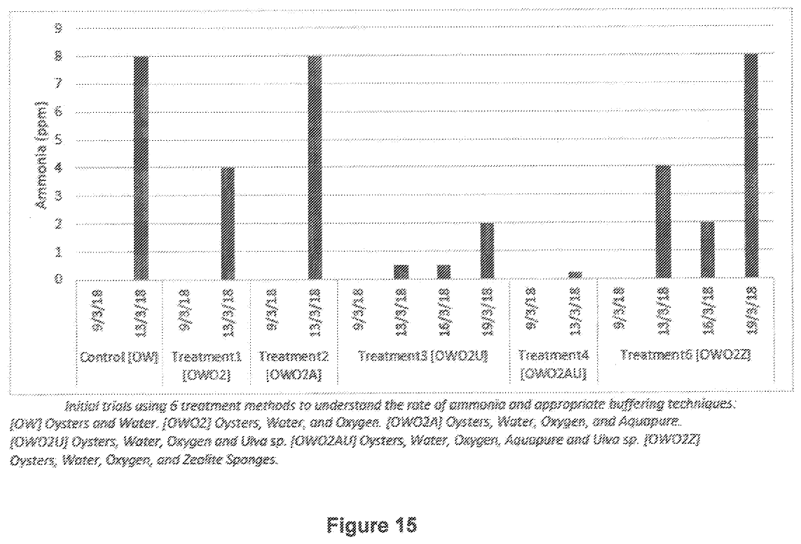

A package of pre-treated oysters placed in sterile seawater supersaturated with oxygen gas in the absence of the addition of oxygen to the package headspace or ammonia-control agent to the seawater was used as a control. The ammonia levels (in ppm) were measured using API ammonia testing kits after approx. 4 days (in some trials testing continued for 7 days and 10 days after sealing of the packages). A stock solution of each ammonia-control agent was prepared by dissolving 1 g of agent in 10 mL of distilled water and was applied to each testing group (as required) at a concentration of 1 to 2 mL/L. Seawater supersaturated with oxygen gas was used for each testing group. The results of these initial trials are shown in FIG. 15.

The results of the initial trials confirmed that after approx. 4 days, the ammonia levels in the control package (oysters placed in supersaturated (O₂) and sterile seawater in the absence of the addition of any ammonia-control agent or oxygen gas to the packaging headspace) exceeded 8 ppm (note, 8 ppm is the maximum amount of ammonia able to be detected by the API testing equipment).

The results of the initial trials also confirmed that the Ulva sp. preparation outperformed the other two preparations tested, in which comparatively low levels of ammonia were detected even after 7 days (0.5 ppm) and 10 days (2 ppm) of testing. However, whilst the Ulva sp. preparation showed promise for avoiding ammonia accumulation, the introduction of associated invertebrate communities to the packaging as a result of the addition of this preparation would subsequently pose further issues. Accordingly, the Ulva sp. preparation was removed from further consideration.

The Zeolite preparation also performed comparatively well in terms of its ability to avoid the accumulation of ammonia from the packaging, however, these sponges are designed for continuous flow filtration and hence their ability to prevent, or reduce, the accumulation of ammonia became negligible by day 10 of testing. Accordingly, the use of the Zeolite preparation was removed from further consideration.

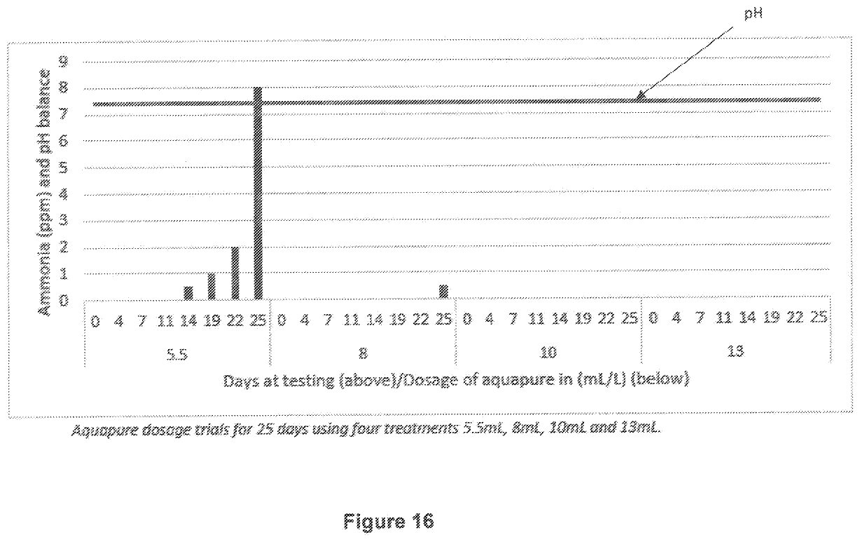

Since the Aquapure preparation did not introduce any additional biological material and did not require continuous flow filtration, a further trial was conducted to determine the optimal concentration (mL/L) of Aquapure stock solution (1 g/10 mL distilled water) required to be added to an aqueous-based liquid medium in order to avoid the accumulation of ammonia in substantial amounts as a result of the oyster metabolism over a prolonged period. This further trial was conducted for 25 days with 12 oysters placed in a litre of filtered water (using a 2 micron filter) which was supersaturated with oxygen. Four Aquapure treatment groups (5.5 mL/L, 8 mL/L, 10 mL/L, and 13 mL/L) were tested. The results of this further trial are shown in FIG. 16.

As can be seen from FIG. 16, the treatment groups in which the Aquapure preparation was applied at a concentration above at least 8 mL/L performed well and avoided the accumulation of ammonia for at least 22 days.

Accordingly, an Aquapure stock solution (1 g/10 mL) applied at a concentration of 8 mL/L-10 mL/L was pursued as a base line for packaging of oysters.

As a result of the above testing and with reference once again to FIG. 8, Aquapure stock solution prepared using 1 g of dry powder per 10 mL of distilled water, is also added to the sterile seawater (60) in a concentration of between approx. 8-10 mL/L, to avoid, or at least reduce, the accumulation of ammonia in the packaged product after sealing.

Once the oysters are cleaned, sorted and graded, and the seawater is conditioned (i.e., once filtered, sterilized and the ammonia-control agent has been added), the oysters are ready to be packaged.

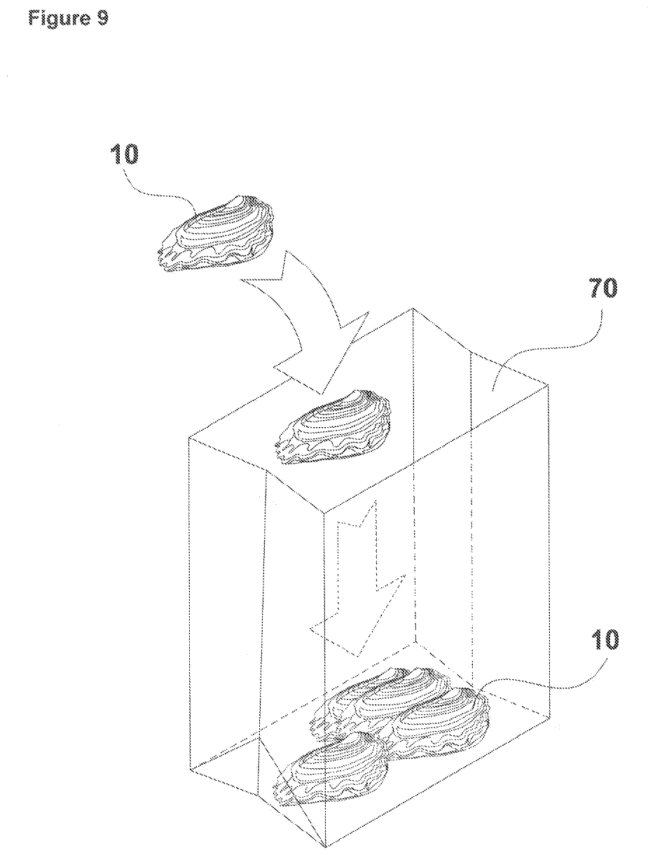

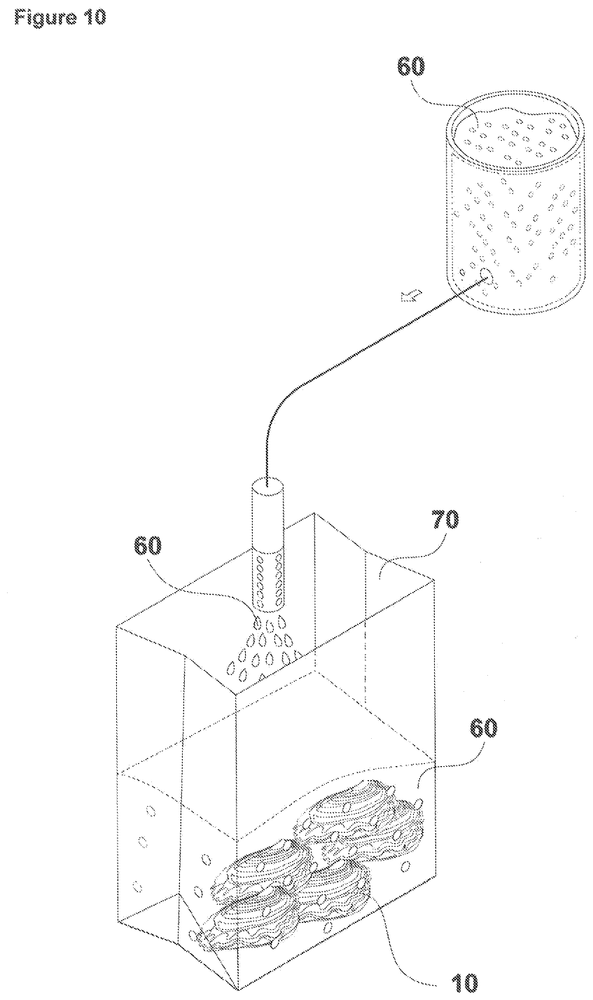

With reference to FIG. 9, a quantity of oysters (typically 12 oysters) is placed in a multi-layer membrane pouch (70) under sanitary conditions. As shown in FIG. 10, pouch (70) is filled with a pre-determined amount of conditioned, oxygen-enriched seawater (60). In this regard, it will be appreciated that the amount of seawater (60) added to the pouch (70) is determined based on the quantity of oysters added to the pouch. Typically, enough seawater (60) will be added to the pouch to allow the presence of a gas headspace in pouch (70).

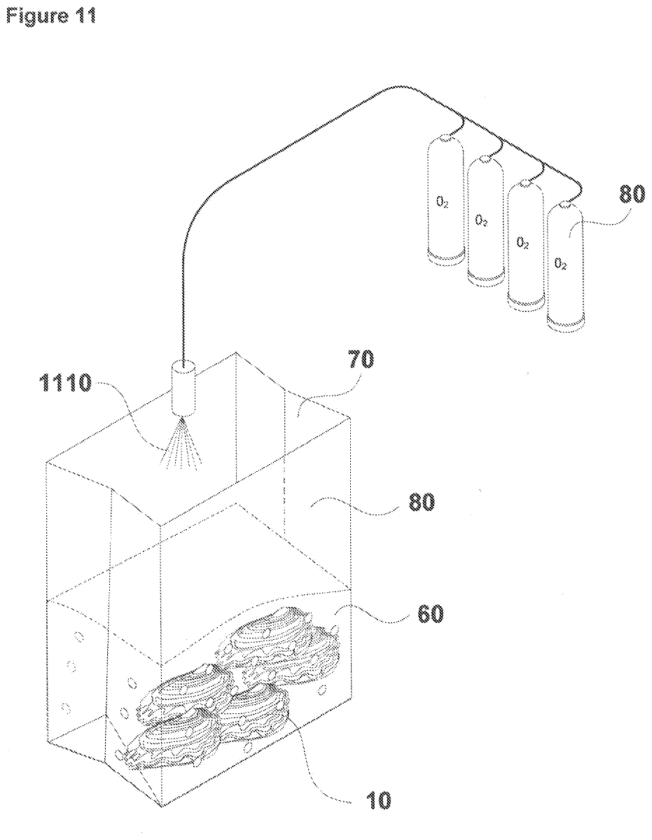

As shown in FIG. 11, once the oysters (10) and oxygen-enriched seawater (60) (with ammonia-control agent) have been added to pouch (70), pure oxygen gas (1110) stored in cylinders (80) is introduced into the headspace of pouch (70). The headspace of the pouch constitutes approx. 60% of the pouch volume thereby allowing oxygen levels in the seawater (60) to be replenished over time (by diffusion of oxygen from the gas phase (headspace) into the liquid phase (seawater) and thereby maintain a high concentration of oxygen in the seawater from the point of packaging of the oysters to the point of opening the package just prior to consumption of the oysters.

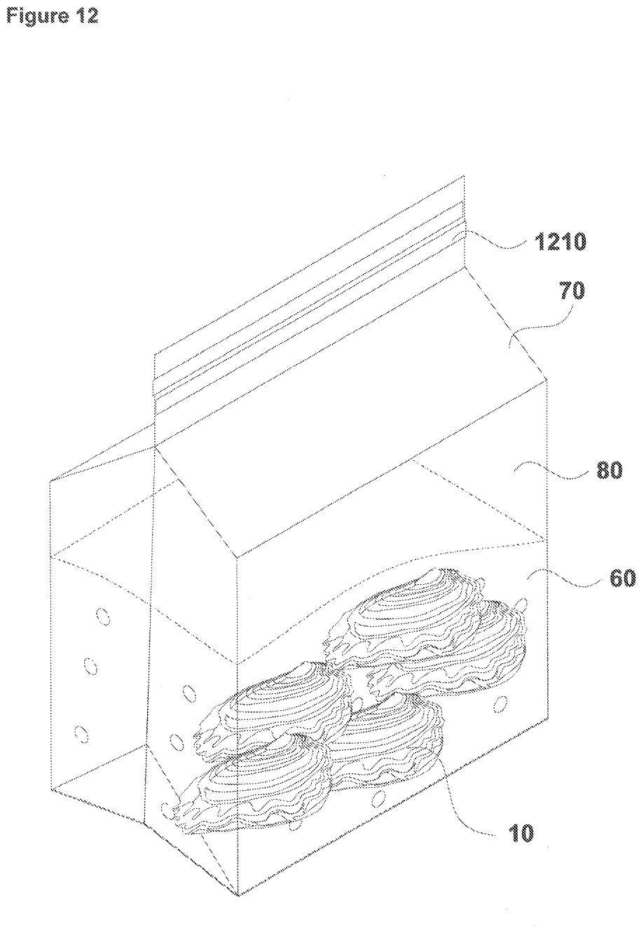

With reference to FIG. 12, the pouch (70) is sealed by means of a heat-bar to form a heat-seal (1210) and thereby retain the live oysters (10), oxygen-enriched seawater (60) and oxygen-filled headspace (80) within the sealed, and non-permeable and impervious pouch (70).

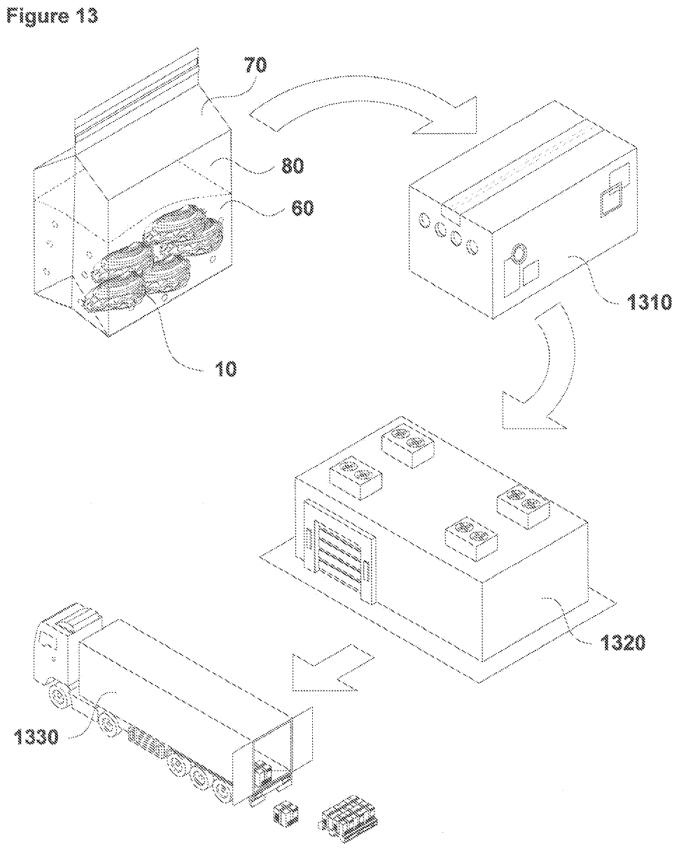

FIG. 13 shows the storage and shipping of the live oysters (10). The sealed pouches (70) are boxed (1310) in preparation for transport where they are stored and maintained between about 2-8° C. in storage warehouse (1320). Due to their prolonged shelf life (about 20 days as a result of the method of packaging according to an embodiment of the present invention), the oysters are able to be transported (1330) in a live condition both domestically and internationally without compromising the quality of the product prior to provision to consumers such as seafood retailers, restaurants and the public.

In an embodiment, a natural salt preparation (1410) is supplied with the package that may optionally be added to the seawater (60) by the consumer after opening the package and prior to removal and consumption of the fresh oysters as shown on serving plate (1420). It will be understood that the natural salt preparation (1410) has an anesthetic effect on the oyster that relaxes the oyster muscle and thereby facilitates the shucking process.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

It will be appreciated by persons skilled in the relevant field of technology that numerous variations and/or modifications may be made to the invention as detailed in the embodiments without departing from the spirit or scope of the invention as broadly described. The present embodiments are therefore to be considered in all aspects as illustrative and not restrictive.

1. A method of packaging live shellfish, the method including:
placing live shellfish in a sealable receptacle;
inserting an oxygen-enriched, aqueous-based liquid medium in the receptacle in an amount that permits a gaseous-phase headspace within the receptacle,
inserting a gas in the receptacle, the gas including oxygen, wherein the gas is inserted in an amount to fill the receptacle headspace with the gas; and
sealing the receptacle to thereby retain the contents of the receptacle in a sealed environment.

2. A method according to claim 1, wherein the aqueous-based liquid medium further includes an agent to substantially avoid the accumulation of ammonia in the aqueous-based liquid medium.

3. A method according to claim 1, wherein the agent is sodium formaldehyde bisulphite.

4. A method according to claim 1, wherein the gas is a mixture of oxygen and one or more other gaseous components.

5. A method according to claim 4, wherein the gas is a mixture of at least about 80% oxygen and 20% of the one or more other gaseous components.

6. A method according to claim 1, wherein the aqueous-based liquid medium is super-saturated with oxygen gas.

7. A method according to claim 1, wherein the temperature of the aqueous-based liquid medium is maintained at a temperature conducive to maintain the shellfish in a live state.

8. A method according to claim 1, wherein the aqueous-based liquid medium is seawater that has been subjected to filtration and/or sterilization.

9. A packaged product for transporting shellfish in a live state, the product including:
a sealed receptacle in which live shellfish are contained;
an oxygen-enriched, aqueous-based liquid; and
a receptacle head-space filled with a gas including oxygen.

10. A packaged product according to claim 9, wherein the packaged product further includes an agent that substantially avoids the accumulation of ammonia in the aqueous-based liquid.

11. A packaged product according to claim 9, wherein the agent is sodium formaldehyde bisulphite.

12. A packaged product according to claim 9, wherein the gas is a mixture of oxygen and one or more other gaseous components.

13. A packaged product according to claim 12, wherein the gas is a mixture of at least about 80% oxygen and 20% one or more other gaseous components.

14. A packaged product according to claim 9, wherein the aqueous-based liquid is super-saturated with oxygen gas.

15. A packaged product according to claim 9, wherein the temperature of the aqueous-based liquid is maintained at a temperature conducive to maintain the shellfish in a live state.

16. A packaged product according to claim 9, wherein the aqueous-based liquid is filtered and/or sterilized seawater.
